(19) United States
(12) Patent Application Publication
(10) Pub. No.: US 2013/0161844 A1
(43) Pub. Date: Jun. 27, 2013

(54) METHOD FOR PRODUCING PLASTIC LENS

(71) Applicants: Norio TAKATORI, Ritto-shi (JP); Kiyonori SATO, Kusatsu-shi (JP)

(72) Inventors: Norio TAKATORI, Ritto-shi (JP); Kiyonori SATO, Kusatsu-shi (JP)

(21) Appl. No.: 13/726,424

(22) Filed: Dec. 24, 2012

(30) Foreign Application Priority Data
Dec. 27, 2011 (JP) 2011-285819
Dec. 27, 2011 (JP) 2011-285820

(51) Int. Cl. B29D 11/00

(52) U.S. Cl. CPC B29D 11/00019
USPC 264/1.1

(57) ABSTRACT

There is provided a method for producing a plastic lens in which, without heating a die, a resin injected and filled into a cavity can be maintained at a temperature higher than a glass transition temperature of the resin only for a time until the filling of the resin into the cavity terminates, whereby the generation of a surface defect such as jetting or a flow mark, or a weld line can be prevented. In producing the plastic lens having a predetermined lens shape by injecting and filling a molten raw material resin into a cavity 3 formed between a movable die 1 and a fixed die 2, a part or all of a molding surface of at least one of inserts 11 and 12 as cavity forming members is formed by using insulating materials 11a and 12a made of a glass raw material.

### TECHNICAL FIELD

The present invention relates to a method for producing a plastic lens.

### BACKGROUND ART

In general, plastic lenses for eyeglasses are produced by an injection molding method using a thermoplastic resin such as a polycarbonate resin or a methacrylic resin, and even for plastic lenses such as progressive refractive power lenses each having a complicated optical surface shapes, the injection molding method makes it possible to transfer a cavity shape of a molding die to the lenses, thereby enabling highly accurate molding.

In the injection molding method, the molding is perform at a lowered die temperature sometimes, for the purposes of improving transfer properties of the die to heighten a quality of molded articles and shortening a cooling time to improve productivity. However, when the molding is performed at the lowered die temperature, there is a tendency to easily bring about a surface defect which is referred to as jetting or a flow mark.

Here, the jetting means a phenomenon that a linear trace appears on the surface of a molded article. That is, during the injection and filling of a molten resin into a cavity through a gate portion, when a flow speed of the resin passing through the gate portion is excessively high or a linear distance from the gate portion to a facing surface in the cavity is long, the molten resin at an initial stage which has been injected into the cavity is linearly or meanderingly filled into the cavity, and is then cooled in an elongate thread-like state as it is. In consequence, there takes place a portion in which the resin is not sufficiently fused with a subsequently injected resin, so that the linear trace appears on the surface of the molded article.

Moreover, the flow mark means a phenomenon that an annual ring-like trace crossing a flow direction of the resin appears on the surface of a molded article. That is, the resin injected and filled into the cavity comes in contact with the surface of the cavity and is cooled, and the cooled resin flows along the surface of the cavity while pushed by a subsequently injected resin and while losing its viscosity. In consequence, the annual ring-like trace crossing the flow direction of the resin appears on the surface of the molded article.

Such problems are noticeably affected by a filling speed of the resin and a temperature of the die. Especially, when the filling speed is excessively low or high, or when the die temperature is comparatively low, the problems take place very easily. Therefore, the problems can be solved by increasing an injection pressure or a hold pressure, or by raising a resin temperature or the die temperature. However, when these countermeasures cannot be taken, various measures including an improvement of a die structure are taken.

For example, Patent Document 1 discloses a method in which the thickness of a cavity in the vicinity of a gate portion is made to be variable, whereby the thickness of the cavity near to the gate is regulated in accordance with a die temperature, to prevent the generation of the jetting.

Moreover, Patent Document 2 discloses a method in which a cavity preheating section to heat the compressed air and supply the heated air into the cavity is disposed to blow hot air onto the surface of the cavity, whereby the cavity surface is preheated to a glass transition temperature or more of a resin to be molded, and injection molding is then performed, thereby preventing the generation of the flow mark.

In the injection molding of the plastic lens, when a lens shape has an uneven thickness, the flow of the resin in the cavity becomes uneven. When the unevenness is remarkable, there occurs a problem that a quality of the molded plastic lens might be impaired.

For example, when the thickness of the center of the lens is small and the thickness of a peripheral edge portion of the lens is large as in a minus lens (a concave lens), the flow of the resin injected into the cavity through the gate portion is disturbed in the center of the lens. Then, while a resin which flows along the peripheral edge portion of the lens is filled into the cavity in a wrap-around state prior to the resin whose flow is disturbed in the center of the lens, the resins join each other on a side opposite to the gate portion to accomplish the filling. Therefore, in the lens peripheral edge portion on the side opposite to the gate portion, there is a tendency that a linear trace referred to as a weld line easily takes place, when the resins flowing through the cavity are joined in the wrap-around state along the lens peripheral edge portion. If such a weld line takes place, the quality of the molded plastic lens is adversely affected by a defect of appearance, a deterioration of strength, and the like.

For preventing the generation of such a weld line in a usual technology concerning the injection molding, for example, Patent Document 2 discloses a method in which the cavity preheating section to heat a compressed air and supply the heated air into the cavity is disposed to blow the hot air onto the surface of the cavity, whereby the cavity surface is preheated to the glass transition temperature or more of the resin to be molded, and then the injection molding is performed, thereby preventing the generation of the weld line.

Furthermore, Patent Document 3 discloses a die for injection molding in which a heating element is received in a concave receiving portion formed in a die surface, to heat a region of the die surface on which the generation of the weld line is predicted.

### RELATED ART DOCUMENTS

### Patent Documents

[Patent Document 1] JP-U1-62-180511

[Patent Document 2] JP-A-06-143319

[Patent Document 3] JP-A-2003-80574

### SUMMARY OF THE INVENTION

### Problems to be Solved by the Invention

However, in the method of Patent Document 1, it can be expected that the generation of the above-mentioned jetting is suppressed by regulating the thickness of the cavity in the vicinity of a gate, but the generation of the above-mentioned flow mark cannot be suppressed. Furthermore, since the die has the movable portion therein, there is another problem that the structure of the die becomes complicated.

Moreover, in each method of Patent Documents 2 and 3, a device to heat the die and a die structure for the heating are required, which causes problems such as the deterioration of durability due to the complicated structure and the increase in manufacturing costs. Furthermore, when the die is to be heated, a long time is taken to cool and solidify a resin filled into the cavity, and hence a molding cycle is prolonged. In addition, there is a problem that energy is excessively required to heat the die.

The present inventors have paid much attention to the fact that a resin injected and filled into the cavity is usually set to a temperature higher than a die temperature, and cooling and solidifying of the resin start from the moment of the injection into the cavity, and furthermore, the generation of a surface defect such as the jetting or the flow mark, or a weld line occurs for a time until the filling of the resin into the cavity terminates. Therefore, if a resin temperature can be kept at a temperature higher than the glass transition temperature only for this time, it is possible to prevent the generation of a surface defect such as the jetting or the flow mark, or the weld line. From the above viewpoint, the inventors have intensively investigated, with the result that the present invention has been achieved.

That is, an object of the present invention is to provide a method for producing a plastic lens in which a resin injected and filled into a cavity can be maintained at a temperature higher than a glass transition temperature, without heating the die, only for a time until the filling of the resin into the cavity terminates, whereby it is possible to prevent the generation of a surface defect such as jetting or a flow mark, or a weld line.

### Means for Solving the Problems

A method for producing a plastic lens according to the present invention is a method in which a molten raw material resin is injected into a cavity formed between a pair of divided dies to fill the cavity to produce the plastic lens having a predetermined lens shape. In this case, a part or all of a molding surface to form the cavity is made of an insulating material which is a glass raw material, and the raw material resin is injected and filled into the cavity, to mold the resin into the predetermined lens shape.

### Advantageous Effects of the Invention

According to the present invention, even when a die temperature at injection molding is set to a low temperature to shorten a molding cycle, it is possible to prevent the generation of a surface defect such as jetting or a flow mark.

Furthermore, according to the present invention, in the case of the produce of a minus lens in which the thickness of the center of the lens is small and the thickness of a peripheral edge portion of the lens is large, it is possible to prevent the generation of a weld line, even when the die temperature at the injection molding is set to the low temperature to shorten the molding cycle.

### BRIEF DESCRIPTION OF THE DRAWINGS

FIG. 1 is an explanatory view showing an example of an injection molding apparatus;

FIG. 2 is a cross-sectional schematic view showing a molding die for use in a first example of the present invention;

FIG. 3 is a cross-sectional view obtained by taking along the line A-A in FIG. 2;

FIG. 4 is a cross-sectional view obtained by taking along the line B-B in FIG. 2;

FIG. 5 is an enlarged cross-sectional view of a main part showing an enlarged periphery of a cavity in FIG. 3;

FIG. 6 is a flowchart showing steps in an example of a method for producing a plastic lens according to the present invention;

FIG. 7 is a cross-sectional schematic view showing a molding die for use in a second example of the present invention;

FIG. 8 is cross-sectional view obtained by taking along the line C-C in FIG. 7;

FIG. 9 is a cross-sectional view obtained by taking along the line D-D in FIG. 7; and

FIG. 10 is an enlarged cross-sectional view of a main part showing an enlarged periphery of a cavity in FIG. 8.

### MODE FOR CARRYING OUT THE INVENTION

Hereinafter, examples of the present invention will be described with reference to the drawings.

### First Example

Firstly, a first example of the present invention will be described. A shape of a plastic lens which is an object to be molded in the present example is not particularly limited. The present invention can be applied to a method in which the lens is molded in a state of a semi-finished product thicker than a finished product, and this semi-finished product called the semi-finished lens is then finished into a final shape by post-processing.

### Injection Molding Apparatus

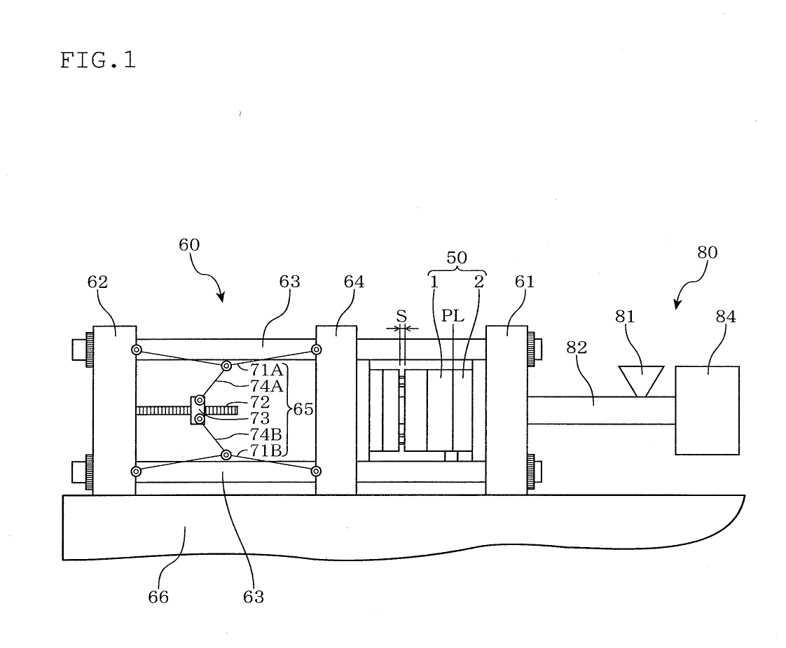

FIG. 1 is an explanatory view showing an example of an injection molding apparatus. A method for producing a plastic lens according to the present example can be carried out by suitably utilizing such an injection molding apparatus.

The injection molding apparatus shown in FIG. 1 includes a molding die 50 having a movable die 1 and a fixed die 2 as a pair of divided dies divided by a parting line PL, a die clamping unit 60 which opens and closes as well as clamps the molding die 50 by a toggle link mechanism 65, and an injection apparatus 80 which melts, kneads and weighs a raw material resin thrown from a hopper 81 in a heating cylinder 82 to inject the resin through a nozzle 85.

### Injection Apparatus

The injection apparatus 80 disposed in the injection molding apparatus shown in FIG. 1 includes the heating cylinder 82 having the nozzle 85 formed at a tip thereof. In the heating cylinder 82, there is disposed a screw whose rotation as well as backward and forward movements are controlled by a drive unit 84.

Moreover, a base end side of the heating cylinder 82 is connected to the hopper 81 to thrown the pellet type raw material resin into the heating cylinder 82. The raw material resin thrown from the hopper 81 into the heating cylinder 82 is sheared and ground by the screw rotating in the heating cylinder 82, and simultaneously molten and kneaded by shear heat and heat from a heater disposed in the heating cylinder 82. Successively, the molten resin is fed to a cylinder front chamber formed between the tip of the screw and the nozzle 85, and then weighed. Afterward, the raw material resin in the molten state is regulated to a viscosity suitable for injection molding, and a predetermined amount of the thus treated resin is then injected through the nozzle 85.

### Die Clamping Unit

In the injection compression molding apparatus shown in FIG. 1, the die clamping unit 60 includes a plurality of tie bars 63 bridged between a fixed die plate 61 and a rear plate 62 which are vertically arranged at a predetermined interval on a frame 66, and a movable die plate 64 is constituted so as to be removable by the guide of the tie bar 63. Furthermore, between the fixed die plate 61 and the movable die plate 64, the molding die 50 is arranged, and between the rear plate 62 and the movable die plate 64, the toggle link mechanism 65 is arranged.

In consequence, when the toggle link mechanism 65 is driven, the movable die plate 64 is guided by the tie bars 63 to move back and forth, and with this movement, the opening and closing as well as the clamping of the molding die 50 are performed.

Here, in the toggle link mechanism 65, a screwed crosshead 73 is constituted so as to move along the ball screw 72 with the rotation of a ball screw 72 connected to an unshown motor. When the crosshead 73 moves to the side of the movable die plate 64, toggle links 71A and 71B extend linearly by connection links 74A and 74B, whereby the movable die plate 64 moves (advances) so as to come close to the fixed die plate 61. On the contrary, when the crosshead 73 moves to the side of the rear plate 62, the toggle links 71A and 71B are inwardly bent by the connection links 74A and 74B, whereby the movable die plate 64 moves (goes back) so as to come away from the fixed die plate 61.

### Molding Die

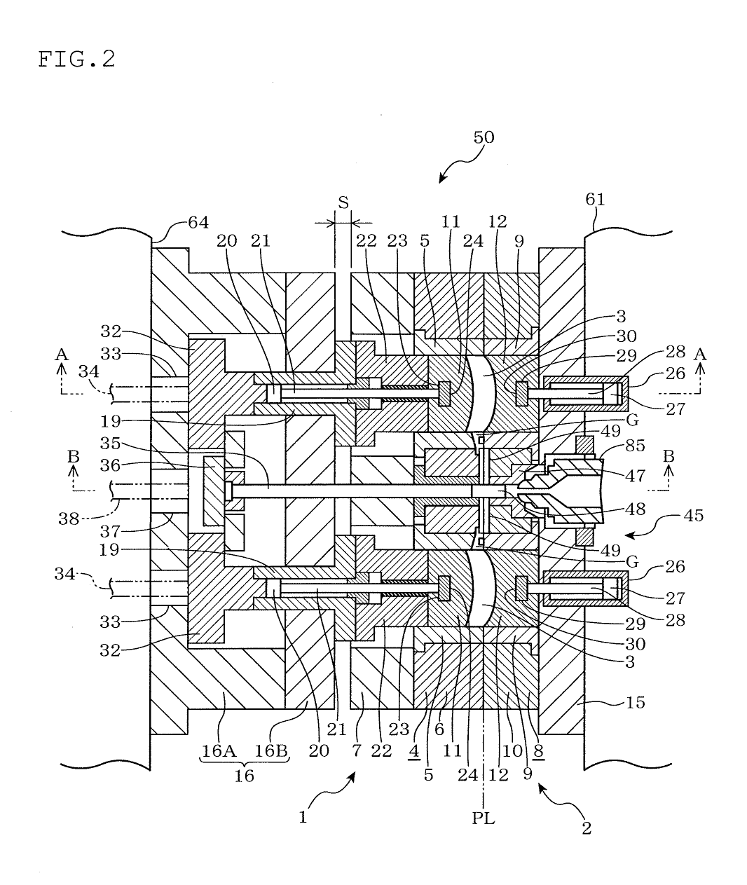

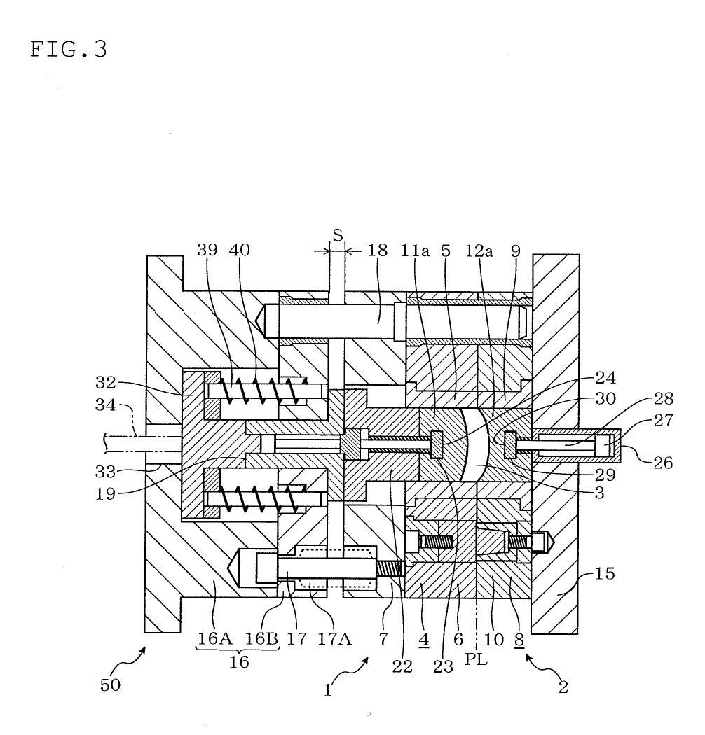

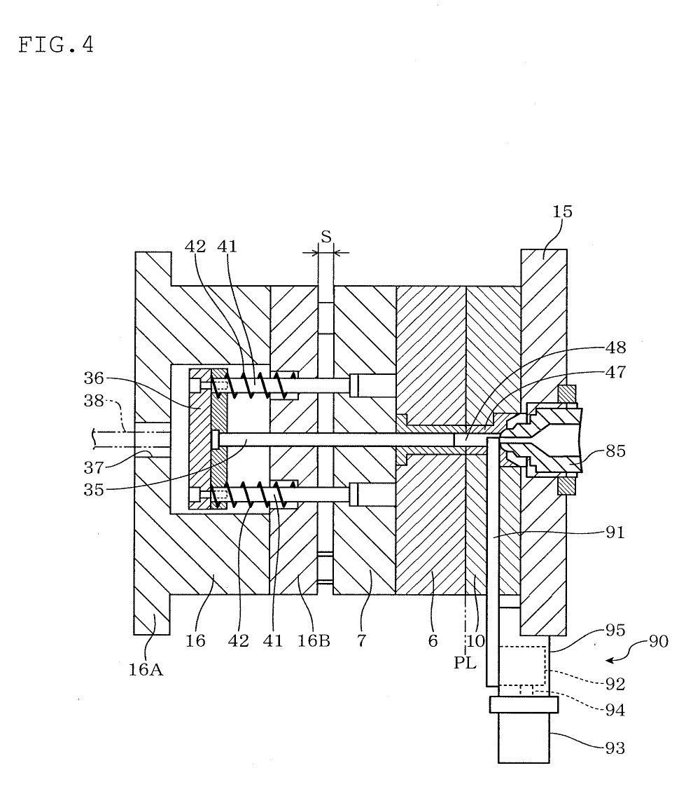

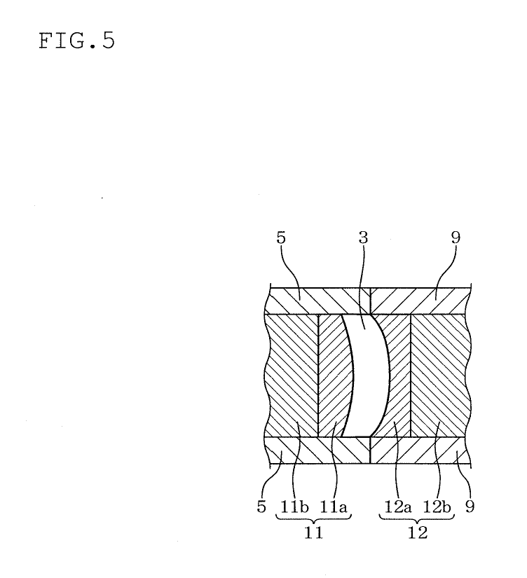

FIG. 2 is a cross-sectional schematic view showing the molding die 50 for use in the present example, and corresponds to the cross-sectional view showing a cross section cut vertically to a paper surface along a central axis of the molding die 50 shown in FIG. 1, to show an initial state of the closed die. Furthermore, FIG. 3 is a cross-sectional view obtained by taking along the line A-A in FIG. 2, FIG. 4 is a cross-sectional view obtained by taking along the line B-B in FIG. 2, and FIG. 5 is an enlarged cross-sectional view of a main part showing an enlarged periphery of a cavity 3 in FIG. 3.

In the example shown in these drawings, between the movable die 1 and the fixed die 2 of the molding die 50 as the pair of divided dies, there are formed the two cavities 3 to mold the plastic lens of the predetermined shape, and runners 49 as resin passages connected to the cavities 3 via gates G, respectively. On a die plate 10 of the fixed die 2, a sprue bush 47 which forms a sprue 48 connected to the runners 49 at right angles is arranged.

A die main body 4 of the movable die 1 includes two insert guide members 5 and die plates 6 and 7 which hold these members. In the insert guide members 5, inserts 11 as cavity forming members are received so as to be slidable in a direction perpendicular to the parting line PL.

Furthermore, a die main body 8 of the fixed die 2 includes two insert guide members 9 and the die plate 10, and the insert guide members 9 are held by the die plate 10 and a die attaching member 15. In the insert guide members 9, inserts 12 as cavity forming members are received so as to be slidable in the direction perpendicular to the parting line PL.

It is noted that the insert guide members 5 and 9 and the die plates 6 and 10 are provided with a circulation mechanism through which a temperature adjusting fluid supplied from an unshown die temperature adjusting device circulates.

In the molding die 50 having the movable die 1 and the fixed die 2, between the movable die 1 and the fixed die 2, there are formed the cavities 3 including molding surfaces which are respectively formed on the inserts 11 on the side of the movable die 1 and the inserts 12 on the side of the fixed die 2. The cavities 3 are formed corresponding to the shape of the plastic lens to be molded, and the respective molding surfaces of the inserts 11 and 12 which form the cavities 3 are formed by using an insulating material made of a glass raw material.

More specifically, in the insert 11 on the side of the movable die 1, the molding surface corresponding to one surface (a concave surface in the shown example) of the plastic lens to be molded is formed by using an insulating material 11a made of the glass raw material, and the insulating material 11a is joined to an insert main body 11b, thereby forming the insert 11. Similarly in the insert 12 on the side of the fixed die 2, the molding surface corresponding to the other surface (a convex surface in the shown example) of the plastic lens to be molded is formed by using an insulating material 12a made of the glass raw material, and the insulating material 12a is joined to an insert main body 12b, thereby forming the insert 12 (see FIG. 5).

As each of the insulating materials 11a and 12a for the formation of the molding surfaces of the inserts 11 and 12, respectively, there can be used an amorphous glass raw material such as a crown, flint, barium, phosphate, fluorine-containing or fluorophosphate series, but among these materials, an amorphous glass raw material having a thermal conductivity of 0.4 to 1.3 W/m·K is preferably selected and used. Such an amorphous glass raw material is suitable for forming a molding surface whose mirror surface properties can easily be obtained by cutting, polishing or the like and in which a high accuracy is required, and hence such a type of material is suitably used as the insulating material having excellent molding properties in the present invention.

Additionally, it is known that a ceramic material such as silicon nitride or aluminum titanate is usable as the insulating material, but the ceramic material is disadvantageously brittle and easily causes a heat impact breakdown. In addition to these drawbacks, the ceramic material requires sophisticated technology and high costs for obtaining the mirror surface, and hence it is unsuitable for the present invention in consideration of productivity.

The insulating materials 11a and 12a made of such an amorphous glass raw material are preferably formed in a thickness of 3 to 4 mm in consideration of molding conditions so as to sufficiently withstand an injection pressure or a holding pressure during the injection molding. For the purpose of preventing breakage not only at the injection molding but also at handling, the insulating materials can be subjected to a surface treatment by use of reinforced glass, diamond-like carbon (DLC) or the like.

Furthermore, joining the insulating materials 11a and 12a to the insert main bodies 11b and 12b can be accomplished by use of, as an adhesive, a thermosetting resin having a low linear expansion coefficient and an excellent stability in a high-temperature environment. Examples of this kind of thermosetting resin include a thiourethane resin made of a polyisocyanate compound and a polythiol compound as raw materials, and an episulfide resin made of an episulfide compound as a raw material. However, the thiourethane resin is preferable because of having an excellent adherence to the glass raw material, and being advantageous also in view of costs.

The insert main bodies 11b and 12b can be formed by using a steel material such as maraging steel or beryllium copper alloy, but it is preferable to use a steel material having a thermal diffusivity higher than that of the glass raw material used as the insulating material.

In the thus constituted molding die 50, the die main body 4 of the movable die 1 is fixed to the movable die plate 64 via a die attaching member 16, and the die main body 8 of the fixed die 2 is fixed to the fixed die plate 61 via the die attaching member 15. In consequence, between the fixed die plate 61 and the movable die plate 64 of the die clamping unit 60, the molding die 50 is to be arranged.

Additionally, in the die attaching member 16 on the side of the movable die 1, a hydraulic cylinder 19 is disposed for each of the inserts 11, and each of piston rods 21 coupled to pistons 20 is passed through a back insert 22 fixed to one end of the hydraulic cylinder 19. Moreover, a T-shaped clamp member 23 disposed at a tip of each of the piston rods 21 is disengageably engaged with a T-shaped groove 24 formed in the back surface (the surface opposite to the surface on which the molding surface is formed) of the insert 11.

In consequence, in the state where the molding die 50 is opened, the piston rod 21 of each hydraulic cylinder 19 is moved forward to allow the T-shaped clamp member 23 disposed at the tip of each of the piston rods 21 to project from the insert guide member 5, whereby the insert 11 can be exchanged in accordance with the plastic lens to be molded. When the piston rod 21 of each hydraulic cylinder 19 is moved backward, the insert 11 attached to the T-shaped clamp member 23 is received in the insert guide member 5.

Similarly, in the die attaching member 15 on the side of the fixed die 2, a hydraulic cylinder 26 is disposed so as to correspond to each of the inserts 12, and a piston rod 28 coupled to a piston 27 is passed through the die attaching member 15. Moreover, a T-shaped clamp member 29 disposed at the tip of each of the piston rods 28 is disengageably engaged with a T-shaped groove 30 formed in the back surface (the surface opposite to the surface on which the molding surface is formed) of the insert 12.

In consequence, in the state where the molding die 50 is opened, the piston rod 28 of each hydraulic cylinder 26 is moved forward to allow the T-shaped clamp member 29 disposed at the tip of each of the piston rods 28 to project from the insert guide member 9, whereby the insert 12 can be exchanged in accordance with the plastic lens to be molded. When the piston rod 28 of each hydraulic cylinder 26 is moved backward, the insert 12 attached to the T-shaped clamp member 29 is received in the insert guide member 9.

Furthermore, when the die main body 4 of the movable die 1 is fixed to the movable die plate 64, the die main body 4 is attached to the die attaching member 16 constituted of a first member 16A and a second member 16B by means of a bolt 17 as shown in FIG. 3. At this time, between the die main body 4 of the movable die 1 and the die attaching member 16, a plurality of disc springs 17A inserted in the outer periphery of the bolt 17, are interposed, and a space S is to be formed between the die main body 4 of the movable die 1 and the die attaching member 16.

The space S is to be closed when the movable die plate 64 is further moved forward after the molding die 50 is closed and the die attaching member 16 guided by a guide pin 18 is pressed against the elastic force of the disc spring 17A. In the shown example, with this closing, each of the hydraulic cylinders 19 disposed in the die attaching member 16 presses the insert 11 via the back insert 22. Consequently, the volume of each of the cavities 3 at the clamping of the die can be changed, and a molten resin injected and filled into the cavity 3 can be pressurized and compressed by the insert 11.

Additionally, the guide pin 18 projects to the side of the fixed die 2 and is inserted into an insertion hole made in the fixed die 2 so as to also guide the opening/closing operation of the molding die 50.

Furthermore, a pressure receiving member 32 is attached to the other end of the hydraulic cylinder 19 disposed in the die attaching member 16 on the side of the movable die 1. When an eject rod 34 inserted through a hole 33 formed in the die attaching member 16 presses the pressure receiving member 32, the hydraulic cylinder 19, the back insert 22 and the insert 11 are also pressed, whereby the lens molded in the cavities 3 is to be pushed out.

At the same time, in the center of the die attaching member 16, an eject pin 35 is disposed so as to move back and forth in a direction parallel to an opening/closing direction of the molding die 50. When a pressure receiving member 36 attached to the eject pin 35 is pressed by an eject rod 38 inserted through a hole 37 formed in the die attaching member 16, the eject pin 35 is pushed out.

Therefore, in opening the die, the eject rods 34 and 38 is to be moved forward to take out the molded article.

In addition, as shown in FIG. 4, in the pressure receiving member 36, a spring force of a spring 42 wound around the outer periphery of an eject return pin 41 acts on the left side in the same drawing. Furthermore, although not especially shown in the drawing, the pressure receiving member 32 is constituted in like manner so that a spring force acts on the left side in the drawing. In consequence, when the eject rods 34 and 38 are moved backward, the pressure receiving members 32 and 36 are also moved backward to return to a stand-by position.

Moreover, as shown in FIG. 4, the molding die 50 has a nozzle shut mechanism 90 which closes the nozzle 85 of the injection apparatus 80. The nozzle shut mechanism 90 has a nozzle shut pin 91 as a blocking member which projects into the sprue 48 formed by the sprue bush 47. The nozzle shut pin 91 is connected to a piston rod 94 of a hydraulic cylinder 93 via a connection piece 92, and the hydraulic cylinder 93 is fixed to the die attaching member 15 by a cylinder attaching plate 95. In consequence, when the hydraulic cylinder 93 is driven in the state where the nozzle 85 comes in contact with the sprue bush 47 under pressure, the nozzle shut pin 91 projects into the sprue 48 to close the nozzle 85, whereby the counterflow of the resin is prevented.

### Method for Producing a Plastic Lens

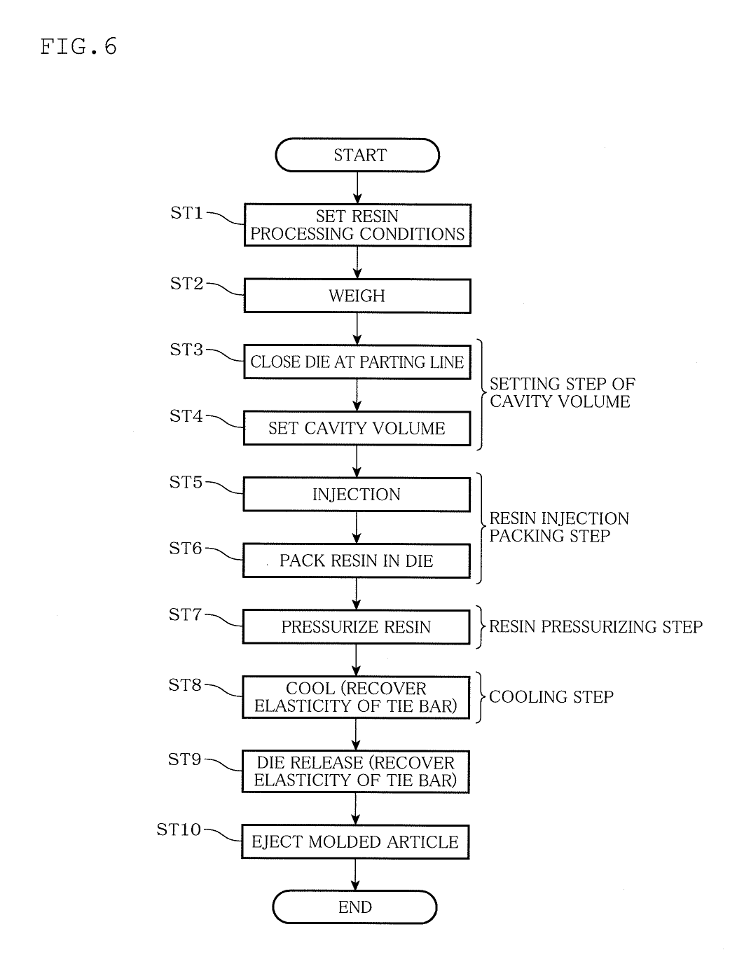

To produce the plastic lens by use of the above injection molding apparatus, for example, steps (an ST1 to an ST10) shown in a flowchart of FIG. 6 can be performed in order.

In the ST1, resin pressurizing conditions are set. This setting is performed to beforehand regulate a die clamping force in accordance with characteristics (a lens shape, a lens power, etc.) of the plastic lens to be molded for the purpose of applying an adequate pressure to the resin in each of the cavities 3.

In the ST2, weighing is performed. In the injection apparatus 80, the pellet type raw material resin thrown from the hopper 81 is sheared and ground by the screw which rotates in the heating cylinder 82, simultaneously molten and kneaded by the shear heat and the heat from the heater disposed in the heating cylinder 82, fed to the cylinder front chamber formed between the tip of the screw and the nozzle 85, and then weighed. Here, a desired amount of the molten resin filled into the cavity 3, the runner 49 and the sprue 48 is weighed.

It is noted that, as the raw material resin, there can be used a thermoplastic resin such as a polycarbonate resin or an acrylic resin which is usually used to mold this type of plastic lens.

In the ST3, the die is closed at the parting line PL. Specifically, when the toggle link mechanism 65 is driven to move forward the crosshead 73, the toggle links 71A and 71 B extend, and the movable die plate 64 moves forward to the fixed die plate 61 to close the molding die 50. At this time, the space S is kept in the state where the disc spring 17A interposed between the die main body 4 of the movable die 1 and the die attaching member 16 is not compressed, and the fixed die 2 and the movable die 1 close at the parting line PL. In this state, the space S is set to the maximum open amount.

In the ST4, the cavity volume is set. From the state where the movable die 1 and the fixed die 2 are brought into close contact with each other at the parting line PL in the ST3, the crosshead 73 is further moved forward to a preset position (a cavity volume setting position). In consequence, the toggle links 71A and 71B extend, and the movable die plate 64 is moved toward the fixed die plate 61 and to a cavity expanding position. A cavity expanding amount is determined by setting a crosshead position. Consequently, the space S of the molding die 50 is decreased while the cavity expanding amount is left. At this time, the volume (the thickness) of the cavity 3 is expanded to be larger than the volume (the thickness) of the lens to be molded, i.e., the thickness of a molded article which is taken out. Moreover, since the disc spring 17A is compressed, a certain amount of the die clamping force is generated owing to a counterforce of the compression.

In the ST5, the injection is performed. The molten resin weighed in the ST2 is injected into the molding die 50 through a passage of the injection nozzle 85. That is, the molten resin, which has been introduced into the heating cylinder 82 of the injection apparatus 80 and weighed, is injected. Then, the molten resin is injected from the nozzle 85 formed at the tip of the heating cylinder 82, and filled into the cavity 3 through the sprue 48, the runner 49 and the gate G. When the molten resin is filled into the cavity 3, an injection speed is controlled to be constant.

In the ST6, the resin is packed in the die. After injecting the predetermined amount of the resin in the ST5, the crosshead 73 is further moved forward immediately before the injection and filling of the molten resin terminates. Then, immediately after the termination of the injection and filling, the nozzle shut mechanism 90 allows the nozzle shut pin 91 to project into the sprue 48, whereby the nozzle 85 is closed. In consequence, the filled molten resin is packed in the molding die 50 in the state where it is compressed and pressurized.

In the ST7, the resin is pressurized. In the ST6, when the crosshead 73 is started to move forward and the crosshead 73 moves forward to an original point (a zero position) to stop at the point, the toggle links 71A and 71B extend to the end. Thus, the molten resin packed in the molding die 50 is compressed and pressurized.

In the ST8, cooling is performed. For the cooling, the temperature of a temperature adjusting fluid is controlled by a die temperature adjusting device 51 so that the temperature of each part (the insert, the insert guide member or the like) of the molding die 50 becomes a set temperature which is equal to or lower than a Tg point in accordance with the characteristics of the lens to be molded. The molten resin packed in the molding die 50 is cooled while keeping the state where the molten resin is compressed and pressurized. In this case, as the raw material resin injected and filled into the cavity 3 is progressively cooled in the state where the resin is pressurized and compressed, the resin solidifies and contracts, to form the plastic lens having a predetermined volume.

In the ST9, a die release operation is performed. In the die release operation, the crosshead 73 of the toggle link mechanism 65 is moved backward to the rear plate 62 to open the molding die 50.

In the ST10, a molded article ejecting operation is performed. When the crosshead 73 is moved backward to the end, a space between the movable die plate 64 and the fixed die plate 61 becomes the largest, and the molding die 50 is divided along the parting line PL to be open. During this die opening, the eject rods 34 and 38 are moved forward to take out the molded plastic lens.

To produce the plastic lens by the above procedure, when the molten resin is injected and filled into the cavity 3 in the ST5, a die temperature is set to a low temperature for the purpose of shortening a molding cycle. In this case, there is a tendency to easily generate a surface defect referred to as a jetting mark or a flow mark on the surface of the molded plastic lens.

In the present example, to prevent the generation of such a surface defect, the molding surface of the insert 11 on the side of the movable die 1 and the molding surface of the insert 12 on the side of the fixed die 2 which form the cavity 3 are formed with the insulating materials 11a and 12a made of the glass raw material, respectively. That is, since the molding surfaces of the inserts 11 and 12 are formed with the insulating materials 11a and 12a made of the glass raw material, respectively, the temperature drop of the molten resin which has flowed into the cavity 3 can be suppressed, which makes it possible to maintain the molten resin in the cavity 3 at a temperature higher than the glass transition temperature of the resin, until the filling of the molten resin into the cavity 3 terminates, even when the die temperature at the injection molding is set to the low temperature to shorten the molding cycle.

In consequence, the deterioration of a viscosity of the resin which flows on the surface of the cavity 3 is prevented, and hence it is possible to effectively avoid the generation of a surface defect such as the jetting or the flow mark.

Thus, to prevent the generation of a surface defect such as the jetting or the flow mark, it is preferable that the insulating materials 11a and 12a which form the respective molding surfaces of the inserts 11 and 12 are formed by using the glass raw material having a thermal conductivity of 0.4 to 1.3 W/m·K, as described above.

In the present example, the glass raw material having such a thermal conductivity is used as the insulating materials 11a and 12a to form the respective molding surfaces of the inserts 11 and 12, and the die temperature and a resin temperature at the injection are set for performing the injection molding so that the surface temperature of the raw material resin is maintained at the temperature higher than the glass transition temperature until the filling of the raw material resin into the cavity 3 terminates. In consequence, the generation of a surface defect such as the jetting or the flow mark can more securely be prevented. At this time, if the thermal conductivity of the glass raw material used as the insulating materials 11a and 12a is in excess of the above range, there is a tendency that an insulating effect cannot sufficiently be obtained. On the other hand, if the thermal conductivity is under the above range, the insulating effect becomes higher than necessary, and a time required for the cooling is prolonged. Therefore, this is not preferable to shorten the molding cycle.

When the surface temperature of the raw material resin is kept higher than the glass transition temperature even after the filling of the raw material resin in the cavity 3 terminates, the intention of shortening the molding cycle is disturbed. Therefore, it is more preferable to suitably regulate various molding conditions for performing the injection molding so that the surface temperature of the raw material resin becomes lower than the glass transition temperature of the resin at a time when the filling of the raw material resin into the cavity 3 has terminated.

Furthermore, in the present example, the molding surfaces of the inserts 11 and 12 are formed with the insulating materials 11a and 12a, thereby suppressing the temperature drop of the molten resin which has flowed into the cavity 3. On the other hand, for the purpose of promoting heat release from the insert main bodies 11b and 12b joining to the insulating materials 11a and 12a to shorten the cooling time after the molding, the insert main bodies are preferably formed by using the steel material having the thermal diffusivity higher than that of the glass raw material used for the insulating materials 11a and 12a.

### Second Example

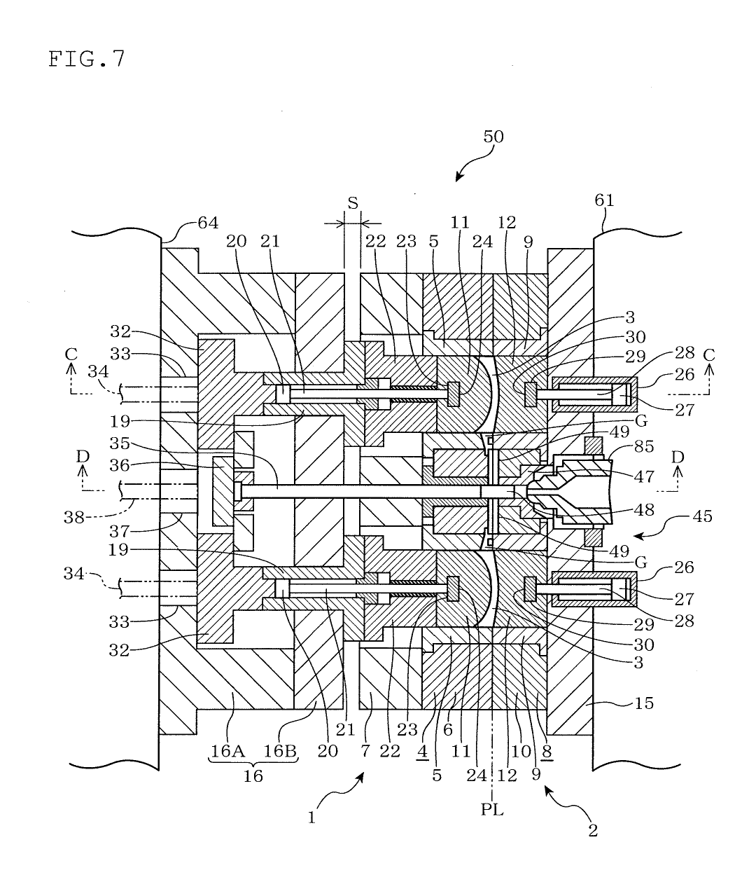

Next, a second example of the present invention will be described. In the present example, an object to be molded is a minus lens (a concave lens) in which the thickness of a lens center is small and the thickness of a lens peripheral edge portion is large. An injection molding apparatus suitable for carrying out the present example is common to the injection molding apparatus suitable for carrying out the first example, except that each of cavities 3 formed between a movable die 1 and a fixed die 2 of a molding die 50 is formed so as to correspond to a shape of the minus lens. Therefore, cross sections of the molding die 50 in which the cavity 3 is formed so as to correspond to the shape of the minus lens are shown in FIG. 7 to FIG. 10, and a common constitution is denoted with the same reference marks and similar descriptions concerning the injection molding apparatus will be omitted.

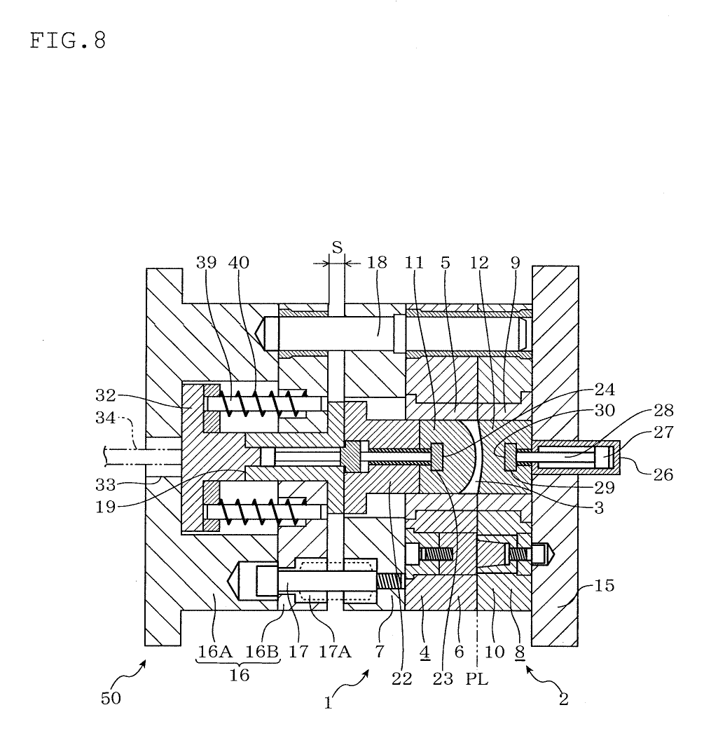

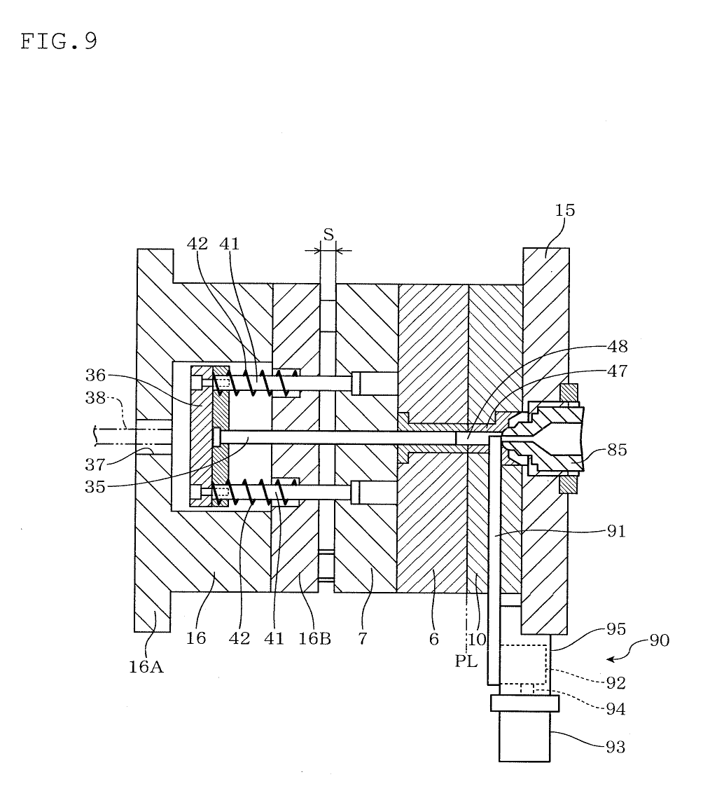

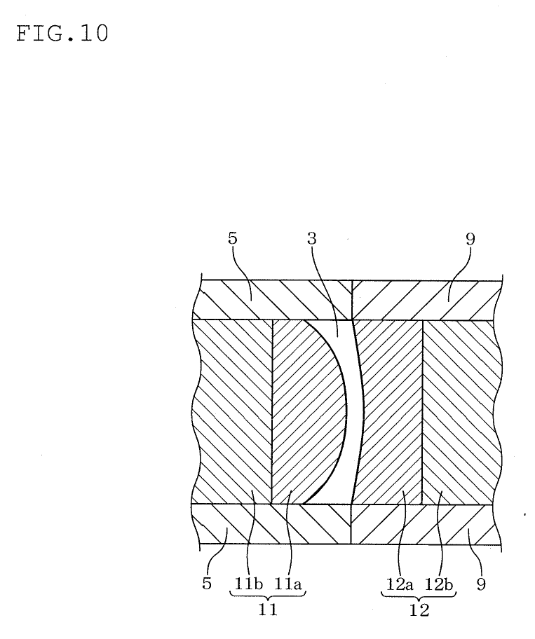

It is to be noted that FIG. 7 is a cross-sectional schematic view showing the molding die 50 for use in the present example, and corresponds to the cross-sectional view showing a cross section cut vertically to a paper surface along a central axis of the molding die 50 shown in FIG. 1, to show an initial state of the closed die. Furthermore, FIG. 8 is a cross-sectional view cut along the line C-C in FIG. 7, FIG. 9 is a cross-sectional view cut along the line D-D in FIG. 7, and FIG. 10 is an enlarged cross-sectional view of a main part showing an enlarged periphery of a cavity 3 in FIG. 8.

Also in the present example, steps (the ST1 to the ST10) shown in a flowchart of FIG. 6 can be performed in order, similarly to the first example. In the case of the production of each plastic lens by such a procedure, there is a tendency to easily generate a linear trace referred to as a weld line. That is, in the ST5, when a molten resin is injected and filled into the cavity 3 to produce each plastic lens where the thickness of the center of the lens is small and the thickness of a peripheral edge portion of the lens is large as in a minus lens (a concave lens) which is an object to be molded in the present example, the flow of the molten resin which has flowed into the cavity 3 through a gate G is disturbed in the center of the lens owing to a hesitation phenomenon. Then, prior to the flow of the resin, a resin which flows along the peripheral edge portion of the lens is filled into the cavity 3 in a wrap-around state, and the resins join each other on a side opposite to the gate G to accomplish the filling of the cavity 3. Therefore, in the lens peripheral edge portion on the side opposite to the gate G, there is a tendency that a linear trace referred to as a weld line easily takes place, when the resins flowing in the cavity 3 are joined in the wrap-around state along the lens peripheral edge portion.

In the present example, to prevent the generation of such a weld line, a molding surface of an insert 11 on the side of the movable die 1 and a molding surface of an insert 12 on the side of the fixed die 2 which form the cavity 3 are formed by using insulating materials 11a and 12a made of a glass raw material, respectively. That is, since the respective molding surfaces of the inserts 11 and 12 are formed by using the insulating materials 11a and 12a made of the glass raw material, the temperature drop of the molten resin which has flowed into the cavity 3 can be suppressed, and the molten resin in the cavity 3 can be maintained at a temperature higher than the glass transition temperature of the resin until the filling of the molten resin into the cavity 3 terminates, even when a die temperature at injection molding is set to a low temperature so as to shorten a molding cycle.

In consequence, the deterioration of viscosities of the resins which join each other in the wrap-around state along the lens peripheral edge portion on the side opposite to the gate G is prevented, so that the resins which have joined each other are sufficiently fused, and hence the generation of the weld line at a predetermined position can effectively be avoided.

Thus, to prevent the generation of the weld line, it is preferable to use the glass raw material having a thermal conductivity of 0.4 to 1.3 W/m·K as the insulating materials 11a and 12a to form the respective molding surfaces of the inserts 11 and 12.

In the present example, the glass raw material having such a thermal conductivity is used as the insulating materials 11a and 12a to form the respective molding surfaces of the inserts 11 and 12. Moreover, for the injection molding, the die temperature and the resin temperature at the injection are set so that the surface temperature of the raw material resin is maintained at the temperature higher than the glass transition temperature until the filling of the raw material resin into the cavity 3 terminates. In consequence, the generation of the weld line can be prevented more securely. At this time, when the thermal conductivity of the glass raw material used as the insulating materials 11a and 12a is in excess of the above range, there is a tendency that it is difficult to obtain a sufficient insulating effect. On the other hand, when the thermal conductivity is under the above range, the insulating effect becomes higher than necessary, and a time required for cooling becomes long. Therefore, this is unfavorable for shortening the molding cycle.

When the surface temperature of the raw material resin is higher than the glass transition temperature even after the filling of the raw material resin into the cavity 3 has terminated, an intention to shorten the molding cycle is disturbed. Therefore, for the injection molding, it is more preferable that various molding conditions are suitably regulated so that the surface temperature of the raw material resin becomes lower than the glass transition temperature of the resin at a time when the filling of the raw material resin into the cavity 3 has terminated.

Furthermore, in the present example, for the purposes of suppressing the temperature drop of the molten resin which has flowed into the cavity 3 by forming the molding surfaces of the inserts 11 and 12 with the insulating materials 11a and 12a, and, on the other hand, shortening a cooling time after the molding by promoting heat release from insert main bodies 11b and 12b to which the insulating materials 11a and 12a are joined, it is preferable to form the insert main bodies by using a steel material having a thermal diffusivity higher than that of the glass raw material used for the insulating materials 11a and 12a.

### EXAMPLES

Hereinafter, the present invention will be described in more detail with reference to specific examples and comparative examples.

It is to be noted that Example 1 and Comparative Example 1 described hereinafter are the specific example and comparative example of the first example, and

Examples 2 and 3 and Comparative Example 2 are the specific examples and comparative example of the second example.

### Example 1

In an injection molding apparatus shown in FIG. 1, a molding surface of an insert 11 on the side of a movable die 1 and a molding surface of an insert 12 on the side of a fixed die 2 were formed respectively by using insulating materials 11a and 12a which were made of a crown series glass raw material and which had a thermal conductivity of 1.1 W/m·K.

By use of such an injection molding apparatus, a polycarbonate was used as a raw material resin, a resin temperature was set to 290° C., and the setting of a die temperature was changed to 125° C., 115° C., 85° C., 75° C., 55° C. and 35° C., to mold plastic lenses in which the thickness of a lens center was 10 mm, the thickness of a lens peripheral edge portion was 12.5 mm, and a diameter was 77 mm.

The surfaces of the molded plastic lenses were inspected. As a result, when the die temperatures were set to 125° C., 115° C., 85° C., 75° C. and 55° C., any surface defects were not observed, and when the die temperature was lowered to 35° C., minute surface defects were observed.

### Comparative Example 1

Plastic lenses were molded in the same manner as in Example 1 except that both of an insert 11 on the side of a movable die 1 and an insert 12 on the side of a fixed die 2 were formed by using maraging steel.

The surfaces of the molded plastic lenses were inspected. As a result, when a die temperature was set to 125° C., any surface defects were not observed, but when the die temperature was set to 115° C., minute surface defects were observed, and when the die temperatures were set to 85° C., 75° C., 55° C. and 35° C., clear surface defects were observed.

From the above results, it was confirmed that according to the present invention, even when the die temperature at injection molding was set to a lower temperature to shorten a molding cycle, the generation of a surface defect such as jetting or a flow mark could be suppressed.

### Example 2

In an injection molding apparatus shown in FIG. 1, each of a molding surface of an insert 11 on the side of a movable die 1 and a molding surface of an insert 12 on the side of a fixed die 2 was formed by using insulating materials 11a and 12a which were made of a crown series glass raw material and which had a thermal conductivity of 1.1 W/m·K.

By use of such an injection molding apparatus, a die temperature was set to 130° C., a resin temperature was set to 290° C., and injection molding was performed to mold minus lenses in which the thickness of a lens center was 1.3 mm, the thickness of a lens peripheral edge portion was 6.5 mm, and a diameter was 77 mm.

The surfaces of the molded plastic lenses were inspected, and as a result, any weld lines were not confirmed.

### Example 3

Injection molding was performed to mold a plastic lens in the same manner as in Example 2 except that a die temperature was set to 85° C. which was lower than in Example 1. The surface of the molded plastic lens was inspected, and as a result, any weld lines were not confirmed.

In this way, the respective molding surfaces of inserts 11 and 12 were formed by using insulating materials 11a and 12a made of a glass raw material. In this case, the temperature drop of a molten resin which had flowed into a cavity 3 could be suppressed, and the molten resin in the cavity could be maintained at a temperature higher than the glass transition temperature of the resin until the filling of the molten resin into the cavity 3 terminated. In consequence, even when the die temperature was set to a temperature which was lower than in Example 2, it was confirmed that any weld lines did not take place.

### Comparative Example 2

A plastic lens was molded in the same manner as in Example 2 except that both of an insert 11 on the side of a movable die 1 and an insert 12 on the side of a fixed die 2 were formed by using maraging steel. The surface of the molded plastic lens was inspected, and as a result, a weld line was recognized.

Now, the preferable examples of the present invention have been described, but the present invention is not limited only to the above-mentioned examples, and needless to say, various modifications and implementations are possible within the scope of the present invention.

For example, in the above-mentioned examples, the whole molding surfaces of the inserts 11 and 12 are formed by using the insulating materials 11a and 12a made of the glass raw material. However, at least a portion of the plastic lens to be molded, in which the generation of a surface defect such as the jetting or the flow mark is predicted, may be formed with the insulating materials 11a and 12a, and even in such a case, the generation of a surface defect such as the jetting or the flow mark, or the weld line can be prevented.

Furthermore, for producing plastic lenses for eyeglasses, a method is known in which each lens is molded in a state of a semi-finished product whose thickness is larger than the thickness of a finished product, and this semi-finished product is then finished into a final shape by post-processing. For example, the known producing method comprises preparing a plurality of types of semi-finished lenses molded into different optical surface shapes on convex sides thereof and into a common concave shape on the concave side thereof, selecting appropriate lenses out of these lenses in accordance with a prescription for a user, and then cutting and polishing each concave surface side of the selected lenses so as to satisfy the prescription, thereby finishing the lenses into a final shape.

In the production of such a semi-finished lens by the injection molding method, even if a surface defect such as the jetting or the flow mark takes place on the surface to be subjected to the post-processing, the surface defect or the flow mark can be removed by the post-processing. Therefore, when the first example is applied for the production of the semi-finished lenses, a part or all of the molding surface of at least one (the die which molds the surface which is not cut or polished by the post-processing) of a pair of divided dies forming the cavity may be formed by using the insulating material made of the glass raw material.

### INDUSTRIAL APPLICABILITY

In the production of plastic lenses by an injection molding method, the present invention can be utilized as a technology which prevents the generation of a surface defect such as jetting or a flow mark, or a weld line.

### EXPLANATION OF REFERENCE MARKS

1 Movable die (divided die)

2 Fixed die (divided die)

3 Cavity

11, 12 Insert

11a, 12a Insulating material

11b, 12b Insert main body

50 Molding die

80 Injection apparatus

1. A method for producing a plastic lens in which a molten raw material resin is injected and filled into a cavity formed between a pair of divided dies, to produce the plastic lens having a predetermined lens shape, the method comprising:
forming a part or all of a molding surface of at least one of the pair of divided dies which forms the cavity, by use of an insulating material made of a glass raw material; and
injecting and filling the raw material resin into the cavity, to mold the raw material resin into the predetermined lens shape.

2. The method for producing the plastic lens according to claim 1, wherein a minus lens in which the thickness of a lens center is small and the thickness of a lens peripheral edge portion is large is an object to be molded.

3. The method for producing the plastic lens according to claim 1, wherein the molding surface is formed by using, as the insulating material, an amorphous glass raw material having a thermal conductivity of 0.4 to 1.3 W/m·K.

4. The method for producing the plastic lens according to claim 1, wherein a surface temperature of the raw material resin is maintained at a temperature higher than a glass transition temperature of the resin, until the filling of the cavity with the raw material resin which has flowed into the cavity terminates.

5. The method for producing the plastic lens according to claim 4, wherein the surface temperature of the raw material resin becomes lower than the glass transition temperature, at a time when the filling of the raw material resin into the cavity has terminated.
